(19) United States
(12) Patent Application Publication
(10) Pub. No.: US 2018/0199563 A1
(43) Pub. Date: Jul. 19, 2018

(54) Mosquitocidal lamp with alarm function

(71) Applicants: Jun ZHENG, Zhejiang (CN); Yuanai NING, Jiangxi (CN)

(72) Inventors: Jun ZHENG, Zhejiang (CN); Yuanai NING, Jiangxi (CN)

(21) Appl. No.: 15/406,803

(22) Filed: Jan. 16, 2017

(51) Int. Cl. A01M 1/22; A01M 1/04; A01M 1/10; G08B 17/10; G08B 7/06; F21V 33/00; F21K 9/23

(52) U.S. Cl. CPC A01M 1/223; A01M 1/04; A01M 1/106; F21K 9/23; G08B 7/06; F21V 33/0076; G08B 17/10

(57) ABSTRACT

A mosquitocidal lamp with alarm function, having an electric mosquitocidal device which has a shell, attracting lights provided inside the shell for attracting mosquitoes, and a high-voltage electric net; the shell is provided with first openings allowing mosquitoes and insects to fly through; the shell of the electric mosquitocidal device is connected with a gas alarm device. A lighting device is also connected to a housing. Compared with prior art, the mosquitocidal lamp with alarm function can kill mosquitoes and at the same time detect the concentration of smoke in the surrounding. Preferably, lighting function is also provided.

### BACKGROUND OF THE INVENTION

The present invention relates to a kind of mosquitocidal device, and more specifically relates to a mosquitocidal lamp with alarm function.

CN204949210U discloses a kind of mosquitocidal lamp comprising an ultraviolet light tube and a base. A middle section of a bottom side of the cavity of the base is provided with a pressure sensor. A photo-catalyst layer is provided at an outer surface of the base. A left side of a middle section of the outer surface of the base is provided with a water inlet. A bottom right end of the outer surface of the base is provided with a water outlet. The ultraviolet light tube is provided at an upper end of the cavity of the base. The base is connected to a bottom side of a support column via a support rod. A bottom part of the cavity of the support column is provided with a storage battery and an inverter. A middle section of the cavity of the support column is provided with a lamp base. A lamp is disposed on an upper surface of the lamp base. A middle section of an outer surface of the support column is provided with a controller. A lower end of the controller is provided with an alarm and an intelligent display. The mosquitocidal lamp is provided with a solar panel at an upper end of the support column, so that solar power can be utilized in lieu of electrical power. As such, energy is saved and users can better utilize the lamp in case of power failure or when the users are in a wild environment.

However, the alarm of the above disclosed lamp is only triggered when there are too many dead bodies of mosquitoes and insects. The lamp does not have monitoring and alarming functions concerning hazards like fire in the surrounding.

### BRIEF SUMMARY OF THE INVENTION

In view of the aforesaid disadvantages now present in the prior art, the present invention provides a mosquitocidal lamp with alarm function, which can realize real-time detection of the concentration of smoke in the surrounding.

The present invention has the following technical solution: A mosquitocidal lamp with alarm function, comprising an electric mosquitocidal device; the electric mosquitocidal device comprises a shell, attracting lights provided inside the shell for attracting mosquitoes, and a high-voltage electric net; the shell is provided with first openings allowing mosquitoes and insects to fly through; wherein the shell of the electric mosquitocidal device is connected with a gas alarm device.

The gas alarm device is a smoke alarm or a fuel gas alarm or a toxic gas alarm or a multifunctional alarm or any kind of alarm available in the prior art.

Preferably, the gas alarm device comprises an alarm circuit board, a buzzer and a sensor.

Advantageously, the shell is connected to a housing; the alarm circuit board and the buzzer are both positioned in the housing; the sensor is positioned outside the housing and electrically connected to the alarm circuit board.

To facilitate transmission of alarm noises, second openings are provided on the housing through which noises emitted from the buzzer are heard.

The housing can be connected to a lighting device.

The lighting device can be selected from any kind available in the prior art according to practical needs. Preferably, the lighting device comprises a light shade connected to the housing; a light source is provided inside the light shade.

The light source may comprise a lighting circuit board; the lighting circuit board is integrated with a plurality of LEDs. Of course, the light source may be embodied as any other kind available in the prior art.

In consideration of integrity and aesthetic appearance of the present invention, the sensor may be mounted on the light shade and exposed from the light shade.

Advantageously, the shell is provided with a threaded portion or a fastening portion for connecting a lamp socket; as such, the present invention generally embodied as a light bulb can be adapted to a currently available lamp socket.

To facilitate cleaning of the dead bodies of mosquitoes and insects, a guiding rail is provided on a base board of the shell; a tray for receiving dead bodies of mosquitoes and insects is removably mounted along the guiding rail by pulling and pushing the tray along the guiding rail; a side wall of the shell is provided with a tray opening so that the tray is capable of being pushed into or pulled out of the tray opening.

A handle that facilitates pulling action is provided on the tray.

Compared with the existing prior art, the mosquitocidal lamp with alarm function provided by the present invention can kill mosquitoes and at the same time detect the concentration of smoke in the surrounding. Preferably, the present invention is also provided with lighting function.

### BRIEF DESCRIPTION OF THE DRAWINGS

FIG. 1 is a perspective structural view of the present invention in an assembled condition.

FIG. 2 is an exploded perspective structural view of the present invention.

FIG. 3 is a vertical sectional view of the present invention.

### DETAILED DESCRIPTION OF THE INVENTION

The present invention will be further described in detail below with reference to the figures and an embodiment.

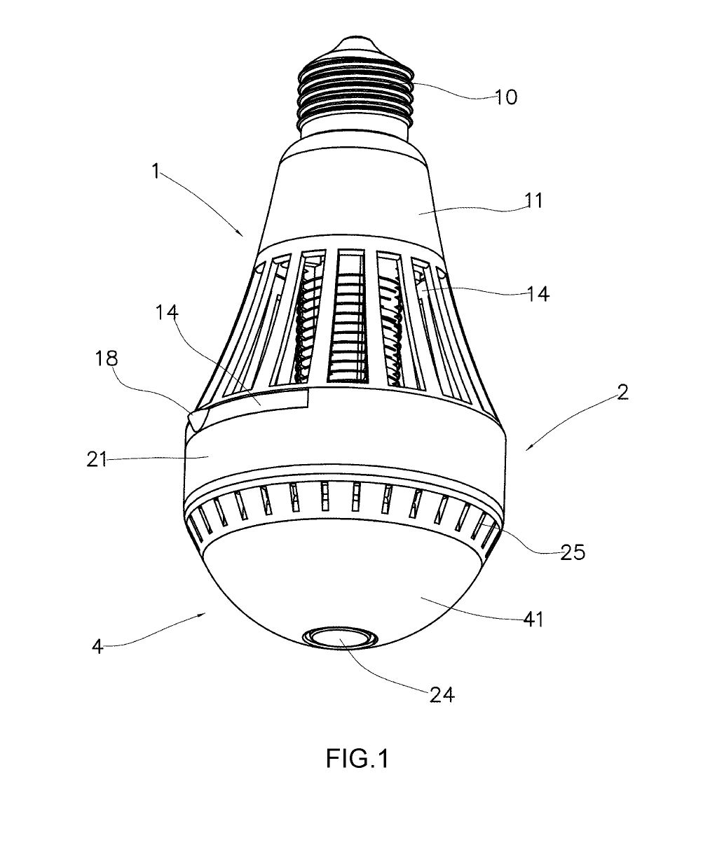

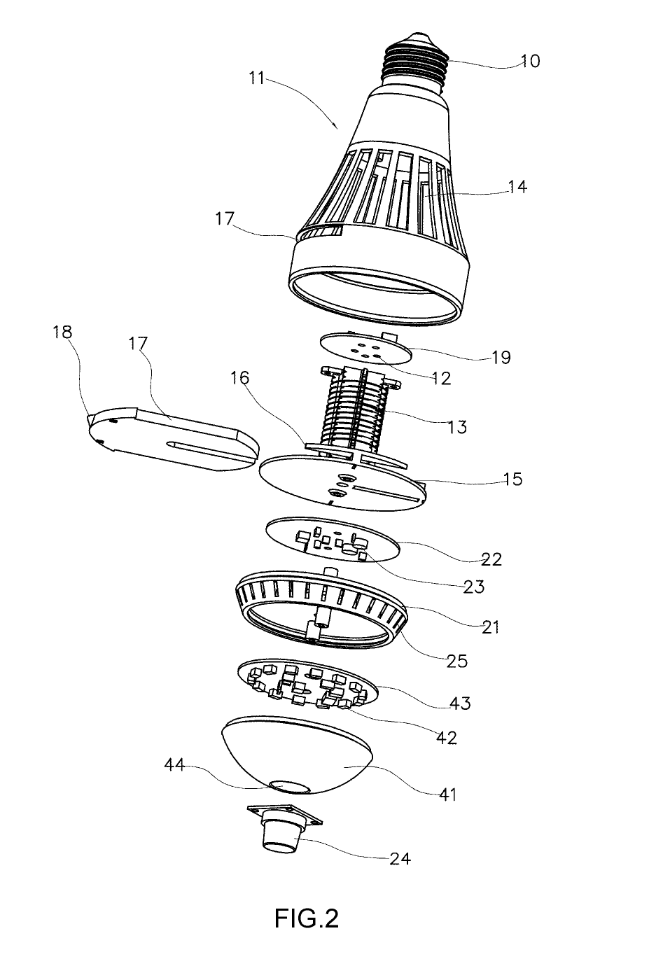

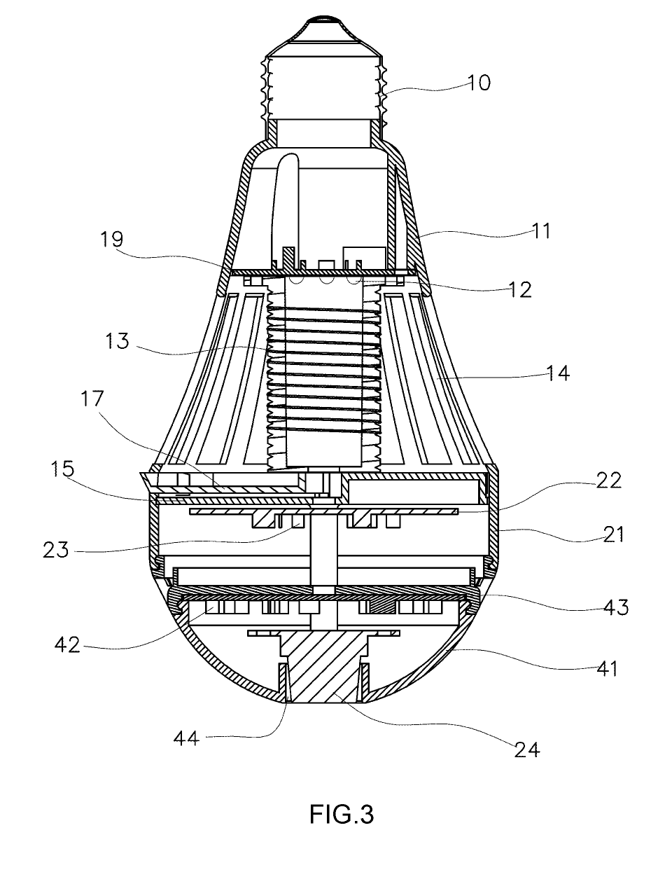

As shown in FIGS. 1-3, a mosquitocidal lamp with alarm function according to the present invention comprises:

An electric mosquitocidal device 1, used for alluring, capturing and causing the death of mosquitoes and insects by electrocution, and can be any kind available in the prior art based on practical situation. The electric mosquitocidal device 1 of the present invention comprises a shell 11, attracting lights 12 provided inside the shell 11 for attracting mosquitoes, and a high-voltage electric net 13; the shell 11 is provided with first openings 14 allowing mosquitoes and insects to fly through; the attracting lights 12 and the high-voltage electric net 13 are both electrically connected to a mosquitocidal device circuit board 19.

A top side of the shell 11 is provided with a threaded portion 10 or a fastening portion for connecting a lamp socket. A threaded portion is shown in the figures. A guiding rail 16 is provided on a base board 15 of the shell 11; a tray 17 for receiving dead bodies of mosquitoes and insects is removably mounted along the guiding rail 16 by pulling and pushing the tray 17 along the guiding rail 16; a side wall of the shell 11 is provided with a tray opening so that the tray 17 is capable of being pushed into or pulled out of the tray opening; a handle 18 to facilitate pulling action is provided on the tray 17.

Also provided is a gas alarm device 2, embodied as a smoke alarm in the present embodiment, used for detecting and evaluating concentration of smoke in the surrounding and triggering an alarm when the concentration of smoke reaches a predetermined level. The gas alarm device 2 comprises a housing 21 connected to the shell 11; an alarm circuit board 22 and an alarm 23 of the gas alarm device 2 are both positioned inside the housing 21; a sensor 24 of the gas alarm device 2 is provided outside the housing 21 and electrically connected to the alarm circuit board 22; second openings 25 are provided on the housing 21 through which noises emitted from the alarm 23 are heard.

The gas alarm device 2 can also be embodied as a fuel gas alarm, a toxic gas alarm, or a multifunctional alarm. Any kind of these alarms available can be used according to practical needs.

Also provided is a lighting device 4, connected to the housing 21, to provide lighting. The lighting device 4 comprises a light shade 41 connected to the housing 21; a lighting circuit board 43 is provided inside the light shade 41; the lighting circuit board 43 is integrated with a plurality of LEDs 42 acting collectively as a light source; a mounting hole 44 is provided on the light shade 41; the sensor 24 is accommodated in the mounting hole 44 and is exposed from the light shade 41; the sensor 24 is electrically connected to the alarm circuit board 22.

When the mosquitocidal lamp with alarm function is powered up, the electric mosquitocidal device operates. Mosquitoes and insects are attracted by the lights from the attracting lights and fly through the first openings into the shell where they are killed by electrocution by means of the high-voltage electric net. Dead bodies of the mosquitoes and insects fall on the tray. The dead bodies of the mosquitoes and insects on the tray can be removed from the tray when the tray is pulled out by pulling the handle.

When the lighting device is powered up, the LEDs are lighted up to provide lighting.

When the gas alarm is powered up, the sensor detects the concentration of smoke in the surrounding; the alarm triggers an alarm when the concentration reaches a predetermined level.

What is claimed is:

1. A mosquitocidal lamp with alarm function, comprising an electric mosquitocidal device (1); the electric mosquitocidal device (1) comprises a shell (11), attracting lights (12) provided inside the shell (11) for attracting mosquitoes, and a high-voltage electric net (13); the shell (11) is provided with first openings (14) allowing mosquitoes and insects to fly through; wherein the shell (11) of the electric mosquitocidal device (1) is connected with a gas alarm device (2).

2. A mosquitocidal lamp with alarm function according to claim 1, wherein the gas alarm device (2) comprises an alarm circuit board (22), a buzzer (23) and a sensor (24).

3. A mosquitocidal lamp with alarm function according to claim 2, wherein the shell (11) is connected to a housing (21); the alarm circuit board (22) and the buzzer (23) are both positioned in the housing (21); the sensor (24) is positioned outside the housing (21) and electrically connected to the alarm circuit board (22).

4. A mosquitocidal lamp with alarm function according to claim 3, wherein second openings (25) are provided on the housing (21) through which noises emitted from the buzzer (23) are heard.

5. A mosquitocidal lamp with alarm function according to claim 3 or 4, wherein the housing (21) is connected to a lighting device (4).

6. A mosquitocidal lamp with alarm function according to claim 5, wherein the lighting device (4) comprises a light shade (41) connected to the housing (21); a light source (41) is provided inside the light shade.

7. A mosquitocidal lamp with alarm function according to claim 6, wherein the light source comprises a lighting circuit board (43); the lighting circuit board (43) is integrated with a plurality of LEDs (42).

8. A mosquitocidal lamp with alarm function according to claim 7, wherein the sensor (24) is mounted on the light shade (41) and exposed from the light shade (41).

9. A mosquitocidal lamp with alarm function according to claim 8, wherein the shell (11) is provided with a threaded portion (10) or a fastening portion for connecting a lamp socket.

10. A mosquitocidal lamp with alarm function according to claim 1, wherein a guiding rail (16) is provided on a base board (15) of the shell (11); a tray (14) for receiving dead bodies of mosquitoes and insects is removably mounted along the guiding rail (16) by pulling and pushing the tray along the guiding rail; a side wall of the shell (11) is provided with a tray opening (17) so that the tray is capable of being pushed into or pulled out of the tray opening.

11. A mosquitocidal lamp with alarm function according to claim 10, wherein a handle (18) that facilitates pulling action is provided on the tray (14).
